(19) United States
(12) Patent Application Publication
(10) Pub. No.: US 2005/0026656 A1
(43) Pub. Date: Feb. 3, 2005

(54) Portable communication device including a camera module

(75) Inventors: Seung-Min Park, Seoul (KR); Chang-Soo Lee, Bupyeong-gu (KR); Sung-Kwon Kim, Gwangmyeong-si (KR); Jun-Sang Park, Anyang-si (KR); Jun Kim, Seoul (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., GYEONGGI-DO (KR)

(21) Appl. No.: 10/811,701

(22) Filed: Mar. 29, 2004

(30) Foreign Application Priority Data
Jul. 16, 2003 (KR) 2003-48608

(51) Int. Cl. H04M 1/00

(52) U.S. Cl. 455/557; 455/550.1

(57) ABSTRACT

A portable communication device including a main housing, a pair of connecting side arms extended lengthwise from both side corners of the main housing, facing each other, and a cylindrical housing, having a speaker on a circular upper surface thereof and a camera lens module on a lower surface thereof, connected to the connecting side arms while a predetermined portion thereof is accommodated between the connecting side arms, so that the cylindrical housing is rotatable around a hinge axis.

### PRIORITY

This application claims priority under 35 U.S.C. § 119 to an application entitled “Portable Communication Device” filed in the Korean Intellectual Property Office on Jul. 16, 2003 and assigned Serial No. 2003-48608, the contents of which are incorporated herein by reference.

### BACKGROUND OF THE INVENTION

1. Field of the Invention

The present invention relates generally to a portable communication device such as a cellular phone, a PDA (Personal Digital Assistant), or an HHP (Hand-Held Phone), and in particular, to a portable communication device that enables an easy transition between a phone mode and a camera operation mode.

2. Description of the Related Art

The term “portable communication device” usually refers to an electronic device that can be carried around with a user, enabling the user to wirelessly communicate with another party. To facilitate the portability of the portable communication device, it is designed to be smaller, slimmer, and more lightweight, while providing a better grip. With regard to functionality, the portable communication device is constantly developing to support multimedia service with a variety of functions. It is expected from the current trend that small, light, multi-function, and multi-purpose portable communication devices will be implemented adaptively according to diverse multimedia and Internet environments. Along with the rapid worldwide proliferation of portable communication devices irrespective of gender and age, they are now seen as a necessity to daily living.

The existing portable communication devices are commonly categorized into a bar type, a flip type, and a folder type, according to their appearance. The bar type is configured to have a bar-shaped single housing. The flip type is configured such that a flip or cover is rotatably mounted to a bar-shaped housing by means of a hinge device, whereas the folder type is configured such that a folder is rotatably mounted to a bar-shaped housing by means of a hinge device so that it is foldable.

The portable communication devices can further be categorized into a neck-wearable type and a writs type according to where or how a user carries them around. Accordingly, the neck-wearable type portable communication device is worn around the neck of a user by means of a strap, and the wrist type portable communication device is worn around his hand.

According to their opening mechanisms, the portable communication devices are classified into a rotation type and a sliding type. The rotation type is configured so that one of two housings is rotated to an open/closed state with respect to the other housing, facing the other housing, and the sliding type is configured such that one of two housings slides to an open/closed state along the other housing. The above classifications of the portable communication devices are known to those skilled in the art.

To satisfy increasing user demands, the portable communication devices have been developed to support high-rate data transmission as well as voice communication. Therefore, they provide services using wireless communication technology for high-rate data communication.

An existing portable communication device further includes a camera lens to transmit video signals. Commonly, a camera lens module is in-built or provided as a separate device in the portable communication device, to conduct a video call or photograph an object therewith.

### SUMMARY OF THE INVENTION

An object of the present invention is to substantially solve the above and other problems and/or disadvantages and to provide at least the advantages below.

Accordingly, an object of the present invention is to provide a portable communication device that enables a fast transition to a phone mode or a camera operation mode.

The above and other objects are achieved by a portable communication device, which includes a main housing, a pair of connecting side arms extended lengthwise from both side corners of the main housing, facing each other, and a cylindrical housing, having a speaker on a circular upper surface thereof and a camera lens module on a lower surface thereof, connected to the connecting side arms while a predetermined portion thereof is accommodated between the connecting side arms, so that the cylindrical housing is rotatable around a hinge axis.

### BRIEF DESCRIPTION OF THE DRAWINGS

The above and other objects, features, and advantages of the present invention will become more apparent from the following detailed description when taken in conjunction with the accompanying drawings in which:

FIG. 1 is a perspective view of a portable communication device according to a preferred embodiment of the present invention;

FIG. 2 is a front view of the portable communication device illustrated in FIG. 1;

FIG. 3 is a bottom view of the portable communication device illustrated in FIG. 1;

FIG. 4 is a perspective view illustrating a 180° rotated state of a cylindrical housing in the portable communication device according to the embodiment of the present invention; and

FIG. 5 is a perspective view of a rotating state of the cylindrical housing in the portable communication device according to the embodiment of the present invention.

### DETAILED DESCRIPTION OF THE PREFERRED EMBODIMENT

A preferred embodiment of the present invention will be described herein below with reference to the accompanying drawings. In the following description,. well-known functions or constructions are not described in detail since they would obscure the invention in unnecessary detail.

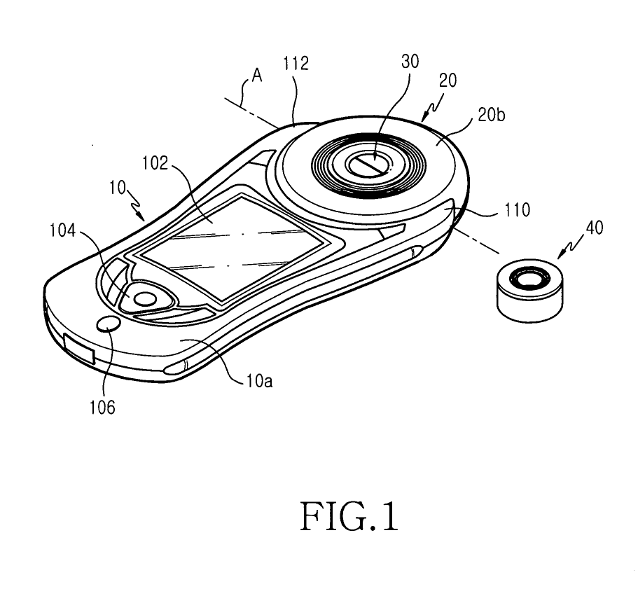

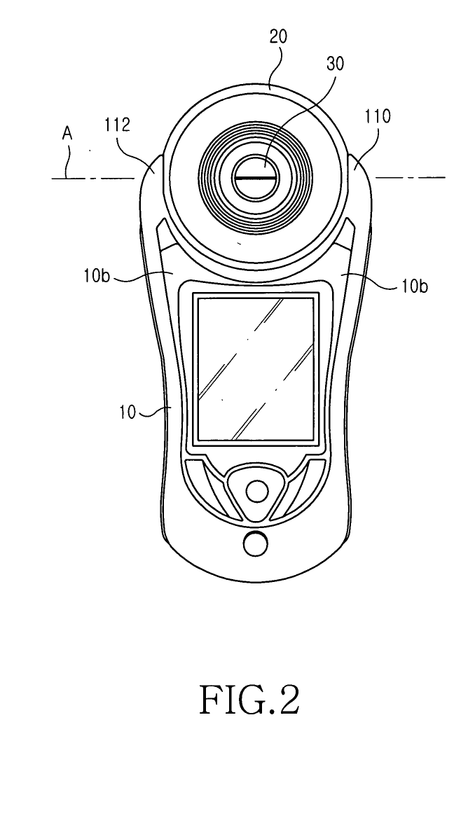

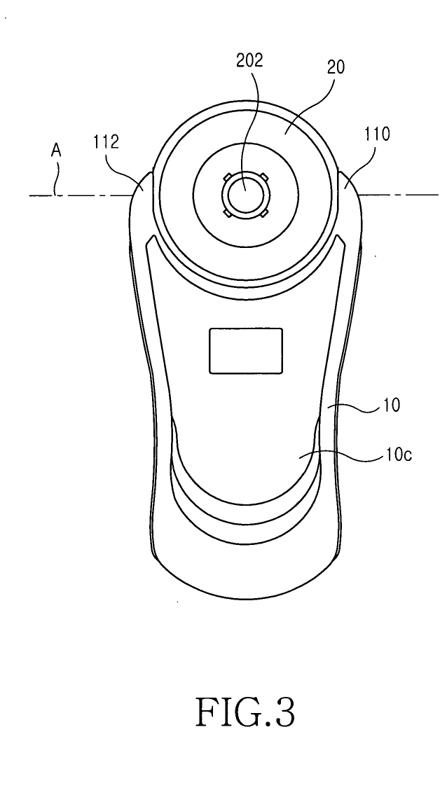

Referring to FIGS. 1 to 5, a portable communication device according to a preferred embodiment of the present invention comprises a bar-shaped housing 10 extended lengthwise and a cylindrical housing 20 connected to the bar-shaped housing 10 by means of a connection device, so that the cylindrical housing 20 is rotatable. The portable communication device further comprises a pair of connecting side arms 110 and 112 extended lengthwise to a predetermined length from both side corners 10b of the bar-shaped housing 10. As indicated above, the cylindrical housing 20 is partially accommodated between the connecting side arms 110 and 112 so that it is rotatable. The connecting side arms 110 and 112 are symmetrically formed, facing each other.

The bar-shaped housing 10 includes an upper surface 10a and a lower surface 10c. On the upper surface 10a of the bar-shaped housing 10 are arranged a display 102, keys 104, and a microphone 106. The keys 104 are arranged below the display 102 and the microphone 106 is below the keys 104. The display 102 is preferably a known LCD (Liquid Crystal Display) module, although, the display 102 is not limited to the LCD module. For example, the display 102 can be a touch-sensitive panel. In this case, a stylus (not shown) would be need needed.

The cylindrical housing 20 includes an upper surface 20a and a lower surface 20b. A speaker 202 is positioned on the upper surface 20a and an exchangeable lens module 30 is positioned on the lower surface 20b of the cylindrical housing 20. The exchangeable lens module 30 is detachable. When necessary, it can be replaced by any of diverse lens modules. In FIGS. 1, 4, and 5, a spare camera lens module 40 is illustrated.

The cylindrical housing 20 is connected to the bar-shaped housing 10, while being partially accommodated between the connecting side arms 110 and 112, so that the cylindrical housing 20 can rotate about 180°.

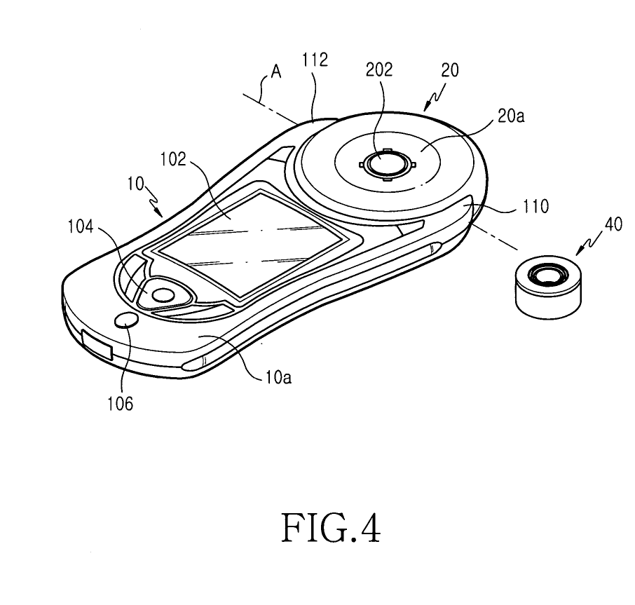

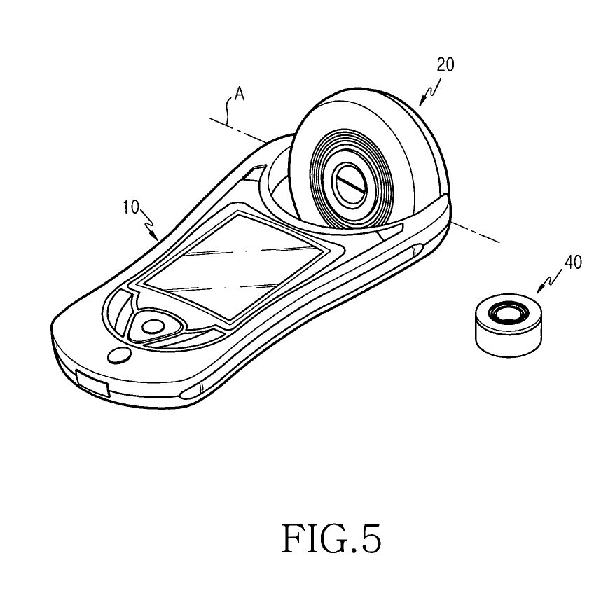

FIG. 1 illustrates the portable communication device in a video call mode, FIG. 4 illustrates the portable communication device in a phone mode or camera operation mode, and FIG. 5 illustrates the cylindrical housing rotating around a hinge axis.

As described above, the present invention offers the benefit of an easy transition between a phone mode and a camera operation mode in a portable communication device.

While the present invention has been shown and described with reference to a certain preferred embodiment thereof, it will be understood by those skilled in the art that various changes in form and details may be made therein without departing from the spirit and scope of the invention as defined by the appended claims.

1. A portable communication device including a camera lens module, comprising:
a main housing;
a pair of connecting side arms extended lengthwise from both side corners of the main housing, facing each other; and
a cylindrical housing including a speaker formed on a circular upper surface thereof and the camera lens module formed on a lower surface thereof, wherein the cylindrical housing is rotatably connected to the pair connecting side arms and a predetermined portion of the cylindrical housing is accommodated between the connecting side arms, so that the cylindrical housing is rotatable around a hinge axis.

2. The portable communication device of claim 1, wherein the main housing comprises, on an upper surface thereof, a display, a plurality of keys arranged below the display, and a microphone positioned below the keys.

3. The portable communication device of claim 1, wherein the cylindrical housing is rotatably connected to the connecting side arms so that the cylindrical housing can rotate 180°.

4. The portable communication device of claim 1, wherein the camera lens module is detachable so that the camera lens module can be replaced by another camera lens module.

5. The portable communication device of claim 1, wherein the main housing is bar-shaped.
